(19) United States
(12) Patent Application Publication
(10) Pub. No.: US 2024/0129784 A1
(43) Pub. Date: Apr. 18, 2024

(54) DYNAMIC FILTERING SYSTEM AND METHOD

(71) Applicant: WiFrost, Inc., Palo Alto, CA (US)

(72) Inventors: Muhammad Qayyum, Palo Alto, CA (US); Tao Chen, Palo Alto, CA (US); Hanxi Chen, Palo Alto, CA (US)

(73) Assignee: WiFrost, Inc., Palo Alto, CA (US)

(21) Appl. No.: 18/379,557

(22) Filed: Oct. 12, 2023

Related U.S. Application Data
(60) Provisional application No. 63/415,836, filed on Oct. 13, 2022.

(51) Int. Cl. H04W 28/02

(52) U.S. Cl. CPC H04W 28/0236; H04W 84/12

(57) ABSTRACT

A system and method for dynamic filtering permits a base station of an unlicensed spectrum communication system to filter out interference from an adjacent transmitter. In one embodiment, the unlicensed spectrum is television whitespace and the adjacent transmitter is a television broadcast transmitter.

### PRIORITY CLAIMS/RELATED APPLICATIONS

This application claims priority under 35 USC 119(e) to U.S. Provisional Patent Application No. 63/415,836 filed on Oct. 13, 2022 titled “Dynamic Filtering System and Method”, the entirety of which is incorporated herein by reference.

### FIELD

The disclosure relates to addressing interference among radio frequency (RF) communication systems and in particular to a system for attenuating interference between a television transmitter and an unlicensed spectrum communications system.

### BACKGROUND

Anytime that two radio frequency (RF) communication systems operate in the same area or at the same or an adjacent frequency, interference is possible. When one of the systems transmits at a significantly greater power level than the other system, the likelihood of interference or an RF front end getting overloaded by the higher power transmitter increases significantly. For licensed spectrum systems, the solution to interference is that each different system operates at its own frequency with guard bands or operates in a different geographic area than the competing system.

When one of the communication systems is an unlicensed spectrum communication system that uses spectrum adjacent to and not being used by a licensed spectrum system, such as television whitespace (TVWS) spectrum, the likelihood of interference is significantly increased. Furthermore, when the unlicensed spectrum communication system uses an unlicensed spectrum, such as TVWS, CBRS or the bands used for Wi-Fi that are unregulated so that there is not the frequency separation or geographic separation, the likelihood of interference also is significantly increased.

For example, in an unlicensed spectrum communication system as shown in FIG. 1, a front end of a base station/eNB 100 of the unlicensed spectrum communication system may be interfered with by a television transmitter 102. In this example, the TV transmitter is 10 miles away from the eNB 100 and is transmitting on the UHF Channel 24. In this example, the TV transmitter is transmitting at a much greater power level than the eNB. As shown in FIG. 2, the TV transmissions overload/overwhelm an RF front end of the eNB 100 as shown by the greater noise level for channel 24 than for any other of the channels as detected by a spectrum scan (RSSI measurements) performed by the eNB. Well known filtering can be used to alleviate some or all of the overloading of the eNB. Furthermore, it is desirable to be able to dynamically adjust the filtering based on the spectrum scan performed at the eNB.

Thus, it is desirable to provide a dynamic filtering system and method for an unlicensed spectrum base station or eNB that overcomes the above interference problem and it is to this end that the disclosure is directed.

### BRIEF DESCRIPTION OF THE DRAWINGS

FIG. 1 illustrates an interference problem between a first unlicensed spectrum transmitter and a second transmitter;

FIG. 2 illustrates a set of measurements showing the interference problem in FIG. 1;

FIG. 3 illustrates an example of an embodiment of an unlicensed spectrum communication system;

FIG. 4 illustrates a method for unlicensed spectrum dynamic filtering;

FIG. 5A illustrates more details of an embodiment of an unlicensed spectrum eNB that performs dynamic filtering;

FIG. 5B illustrates more details of another embodiment of an unlicensed spectrum eNB that performs dynamic filtering;

FIG. 6 illustrates an example of an implementation of a filter block for performing dynamic filtering;

FIG. 7 illustrates an example of an implementation of a television whitespace (TVWS) front end that can perform dynamic filtering; and

FIGS. 8A and 8B illustrate a switch integrated circuit and its truth table wherein the switch integrated circuit may be used to perform dynamic switching.

### DETAILED DESCRIPTION OF ONE OR MORE EMBODIMENTS

The disclosure is particularly applicable to a unlicensed communication system that uses television whitespace (TVWS) unlicensed spectrum and is interfered with by a television transmitter that is alleviated by a dynamic filtering system and it is in this context that the disclosure will be described. Television whitespace are frequencies assigned to a television channel, but not being used that can be repurposed as unlicensed spectrum. It will be appreciated, however, that the dynamic filtering system and method has greater utility since it can be implemented in other known manners than those disclosed below and may be used to reduce/eliminate interference for other unlicensed spectrums such as the frequency spectrum used for Wi-Fi or CBRS or n77. The TVWS spectrum may be between 470 to 698 MHz, the CBRS spectrum may be between 3550-3700 MHz, the n77 spectrum band is a frequency band designated by the 5G NR standard that covers 3300 to 4200 MHz, and Wi-Fi spectrum may be between 2400-2484 MHz and 4900-6450 MHz.

In the various embodiments disclosed below, dynamic configuring of the filtering at each base station may be controlled by a network management system that remotely controls the filters for each particular base station based on network configuration data. The network configuration data for each base station may include RF channel conditions for the base station (determined from the spectrum scan(s) and a location of each of the one or more TV transmitters (distance from base station and elevation difference) that is interfering with the base station. The configuration of the filters for each particular base station may be updated and changed as/when the network configuration data for that particular base station changes.

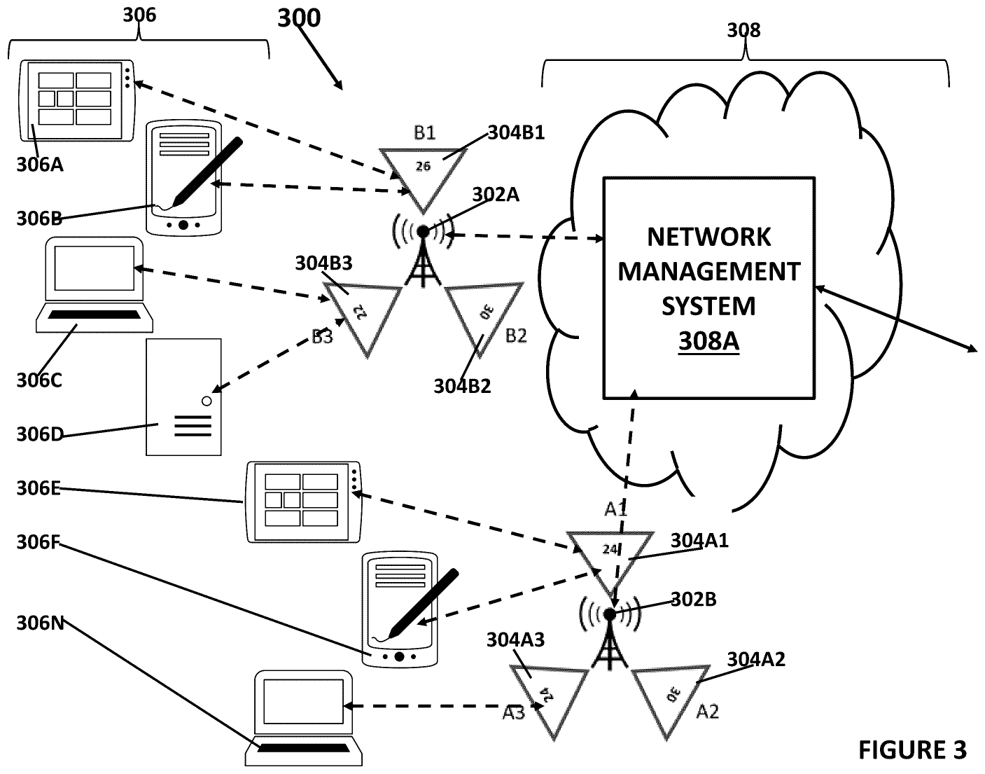

FIG. 3 is a simple exemplary unlicensed spectrum network architecture 300. In this example, television whitespace (TVWS) is the unlicensed spectrum and the network and its architecture and operations will be described in this context. However, the unlicensed spectrum network may also be a Wi-Fi network or CBRS which are each unlicensed spectrum and the architecture may be different from the TVWS, but similar as is known in the art and would need the same dynamic filtering discussed herein. The Wi-Fi network/technology may use frequency bands that include all Unlicensed National Information Infrastructure (UNII) bands from UNII-1 to UNII-8 or “Industrial Scientific & Medical (ISM)” bands.

The TVWS network 300 may include one or more broadcast towers 302 (in the simple example shown, only two broadcast towers 302A, 302B are shown) and each broadcast tower 302 may have one or more base stations 304 that can connect to and communicate data over the unlicensed spectrum with one or more pieces of user equipment (UE) 306. Each broadcast tower 302 may have its own set of channels over which content may be communicated. In the example in FIG. 3, three base stations (eNB) 304B1-304B3 and 304A1-304A3 are shown for each broadcast tower and the UEs 306 can connect to and communicate with any of the base stations/eNBs 304 (although no Ues 306 are shown communicating with base stations 304B2 and 304A2 in the example in FIG. 3. The connections/communication paths between the Ues 306 and the base stations/eNBs 304 are shown by the dotted lines in FIG. 3. Each base station/eNB 304 for each broadcast tower 302 may communicate over a particular channel/sector with the Ues 306 communicating with that base station/eNB. Each base station/eNB 304 may have a sensor circuit that measures the characteristics of the link to the Ues 306 and communicates that data back to a network management system 308A. Thus, as shown in FIG. 3, base station/eNB 304B1 is using channel 26 of the first broadcast tower, base station/eNB 304B2 is using channel 30 of the first broadcast tower, base station/eNB 304B3 is using channel 22 of the first broadcast tower, base station/eNB 304A1 is using channel 24 of the second broadcast tower, base station/eNB 304A2 is using channel 30 of the second broadcast tower and base station/eNB 304B3 is using channel 24 of the second broadcast tower. This combination of channels used at each tower together form a current architecture of the network (channel plan) with the selected channels. However, the quality of the selected channels can degrade so that the network has a network management system 308A that is connected to each base station to adjust the network architecture to maximize end-user throughput for each UE 306.

A network management function 308 may be performed by the network management system 308A as discussed below in more detail. In one embodiment, the network management system 308A may be in a cloud and may be implemented as a plurality of cloud computing resources (processor, storage, application server, database server, etc.). However, the network management system 308A may also be implemented using a standalone computer system having a processor or a computer system operating within a third party network and both implementations are within the scope of the disclosure. In these implementations, there may be a plurality of lines of computer code/instructions that are executed by the processor of the network management system 308A to implement the functions and operations of the network management system 308A discussed below in which the processor is configured to perform those functions and operations as a result of the execution of the instructions/computer code.

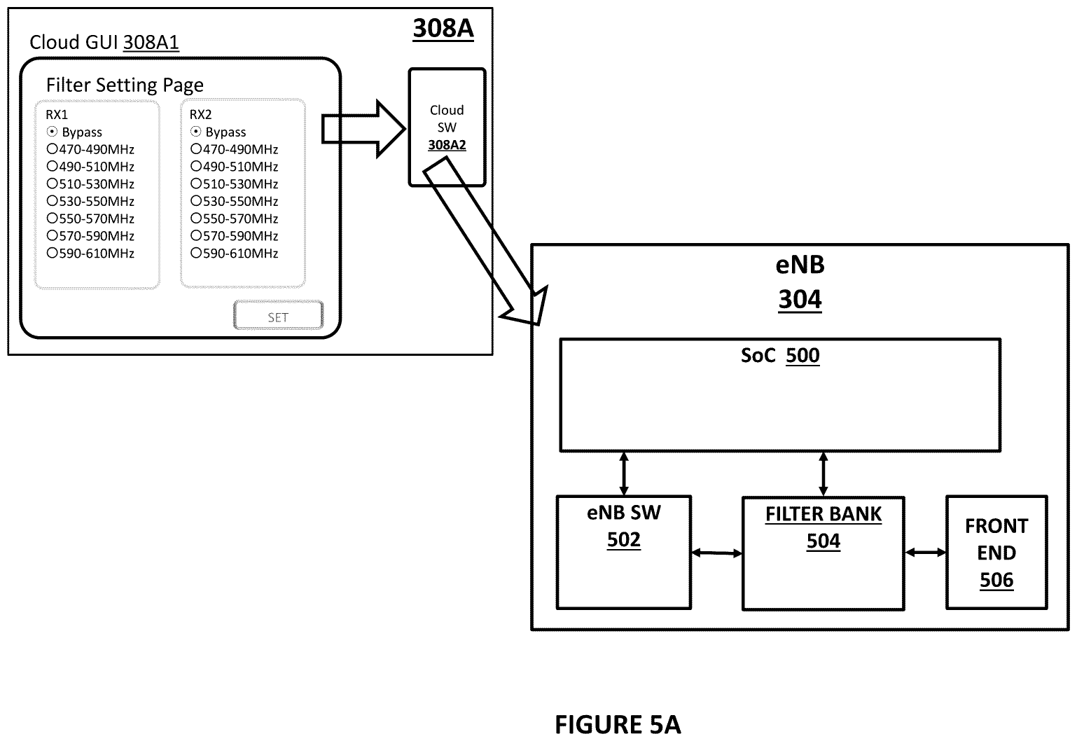

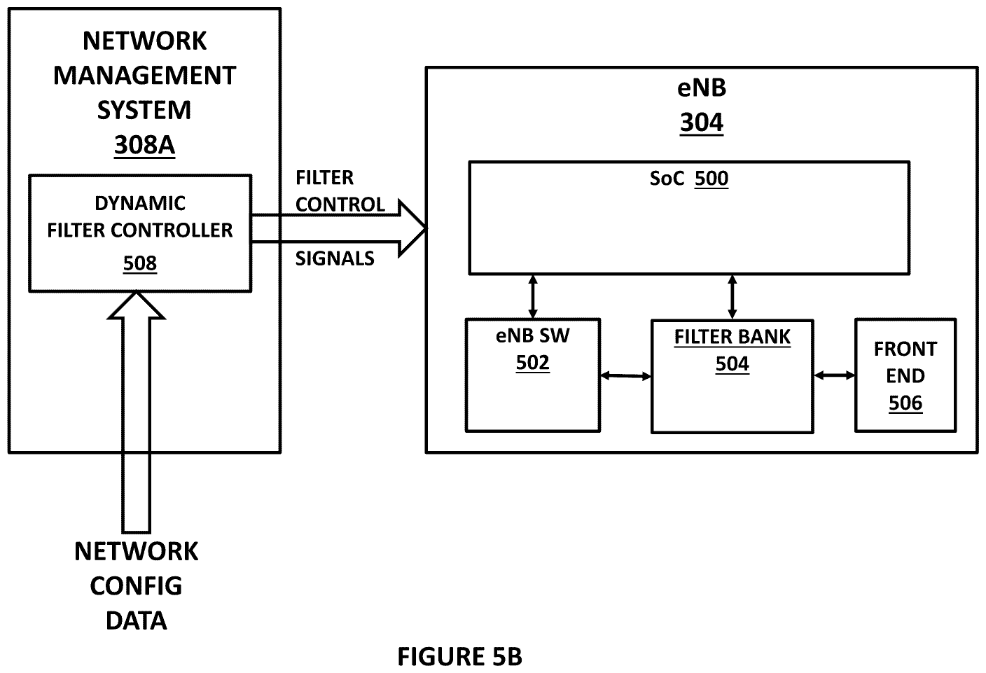

Each UE 306 may be a computing device that has at least a processor, memory and wireless unlicensed spectrum connectivity circuits so that each UE 306 can connect to and communicate with any base station/eNB 304 using the unlicensed spectrum. In some embodiments, each UE 306 may execute a browser application or other application that manages the unlicensed spectrum and connection. The browser application or other application may also sense a network condition for that UE and send that data back to the base station/eNB 304. Alternatively, each UE 306 may have sensing circuitry that is able to measure the network condition. In either case, each EU 306 in the network shown in FIG. 3 goes through the scan procedure per the 3GPP specifications, using the transceiver on the UE module, in the UE device 306 as is well-known in the industry. The spectrum sensing is measured over a 5 MHz or 10 MHz bandwidth across the complete range of the operating frequencies. This spectrum sensing data will be discrete noise floor readings that will be saved in the network management system 308A along with a timestamp and geotag for each UE 306. The frequency of the data set can be changed from the network management system dashboard as shown in FIG. 5A.

Each UE 306 may be, for example, a tablet computer, a smartphone device, a laptop computer, a personal computer. Furthermore, each UE may also be a television, a wireless router in a residence or building and the like and thus may be any device that can communicate over the unlicensed spectrum and benefit from each able to communicate data. The unlicensed spectrum communication system in FIG. 3 may benefit for dynamic filtering and resolve the dynamic filtering technical problem discussed above in the background using an innovative technical dynamic filtering process and system that will now be discussed.

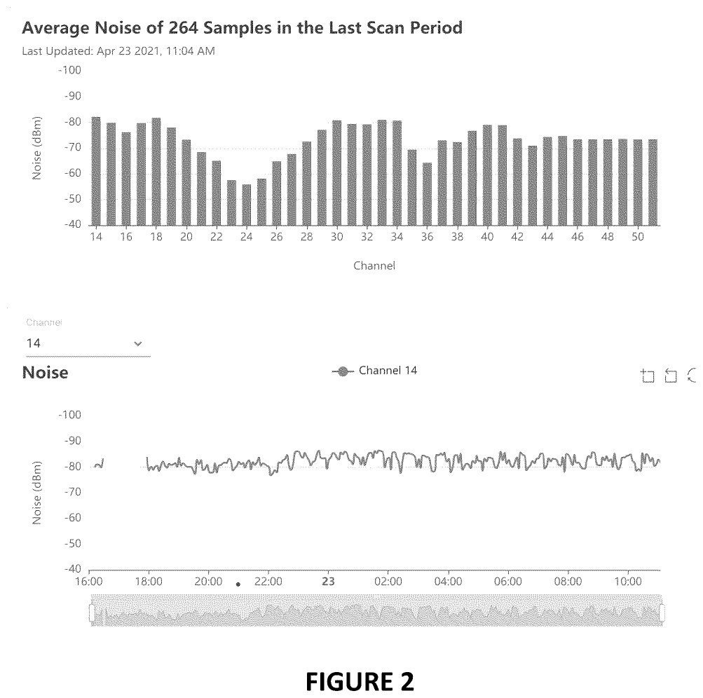

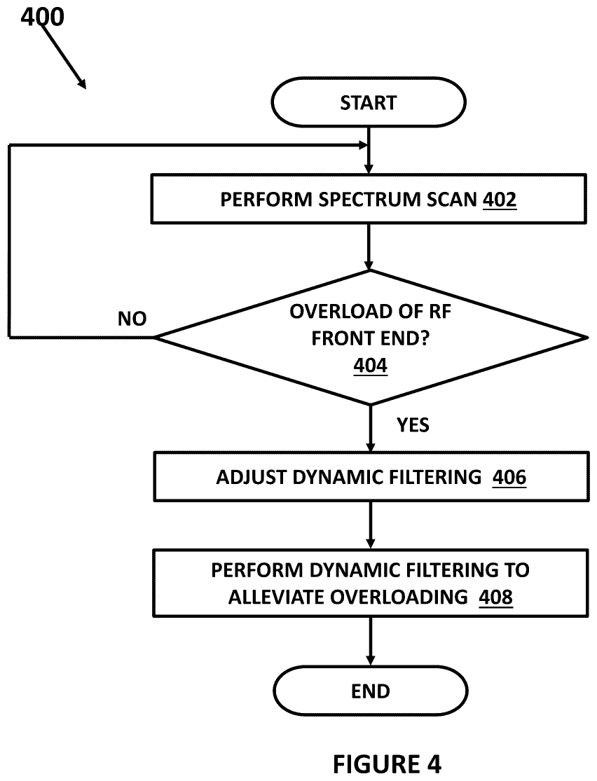

FIG. 4 illustrates a method 400 for unlicensed spectrum dynamic filtering that may be performed by the apparatus shown in FIGS. 5-8A or other computer systems. In one embodiment, the method 400 may be performed by a network management system of an unlicensed spectrum communication system and by a base station/eNB of that unlicensed spectrum communication system. The method may be performed to alleviate interference and overloading of a television whitespace unlicensed spectrum communication system, but may also be used with other unlicensed spectrum (Wi-Fi or CBRS) communication systems. In the method, a spectrum scan (402) is performed that, among other things, measures RSSI and the state/characteristics of each base station/eNB 304 of an unlicensed spectrum communication system to generate the data such as that shown in FIG. 2 and described above. In an embodiment in which the method 400 is being performed by the system in FIG. 3, the network management system 308A may receive a spectrum scan from each base station. Note that the method 400 may be performed for each base station/eNB that is part of the unlicensed spectrum communication system although the method will be described with respect to a single eNB for illustration purposes.

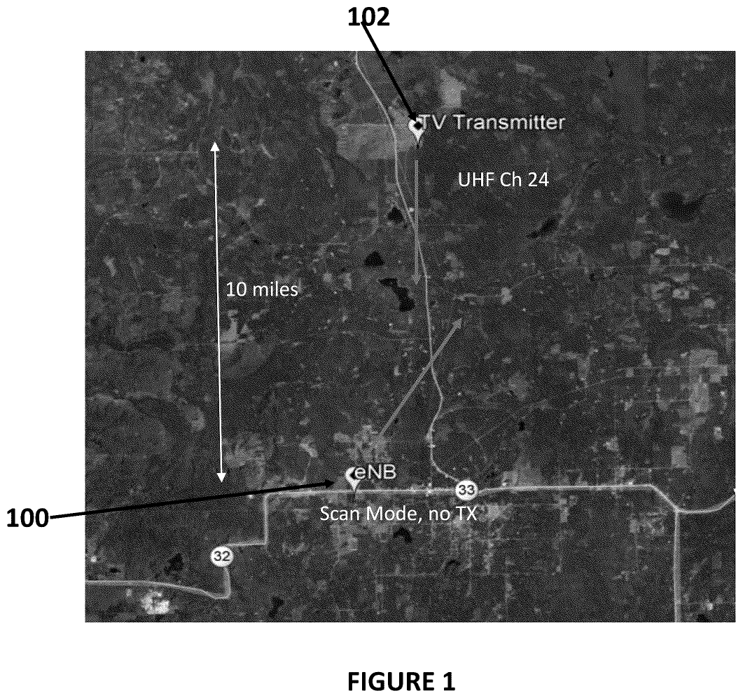

The spectrum scan by each base station/eNB 304 may show evidence of the TV transmitter interference as shown above in FIGS. 1-2. A typical high power TV transmitter radiates at 1 million watts. This power is received at an eNB 304 5-10 miles away at −20 to −30 dBm that is strong enough to saturate or overload the RF front end of the ENB/base station 304 transceiver. In actual operations, these million watt TV transmitters are randomly placed, so it is important to build a system that can block these signals and make a wideband device operation possible regardless of the location of the TV transmitters, the number of interfering TV transmitters and the channel conditions at each ENB/base station 304. This achieved by using automation through firmware and network management software as discussed below with respect to FIGS. 5A and 5B.

When an eNB/base station 304 is set to scan the spectrum, the firmware is programmed to automatically change filters based on the channels that are being scanned, all the way from 470 MHz to 670 MHz when being used in the TVWS spectrum (the scan would be at different frequencies if using CBRS, n77 or WiFi spectrum). This scan data may be compromised due to the million watt TV transmitters. The scan data that is stored in the network management system 308A can now be used to understand the quality of TV spectrum in order to identify clean channels for operation by each base station.

Using the spectrum scan, the method may determine, based on the spectrum scan, whether the radio frequency (RF) front end of an eNB is overloaded by a second transmitter (404). In the embodiment in which the method 400 is being performed by the system in FIG. 3, the network management system 308A may perform this determination such as by determined whether the noise on channel 24 as discussed above is present for the particular eNB. If there is not any overloading caused by an adjacent transmitter, the method loops back to receive another spectrum scan to check/make another determination for the same eNB or another eNB of the system.

If overloading is determined, then the method may adjust the dynamic filtering (406) of the affected eNB. Adjusting the dynamic filtering may involve determining a particular frequency band that is being overloaded and then selecting a filter in a filter bank to perform the filtering and reduce/eliminate the overloading of the RF front end. In the embodiment in which the method 400 is being performed by the system in FIG. 3, a hardware processor/SoC of the eNB 304 may perform this adjustment of the dynamic filtering. Note that the dynamic filtering only filters the frequency bands needed and does not perform filtering unless it is needed thereby reducing the losses incurred by the filtering.

Once the spectrum scan information is recorded and geotagged for all eNBs in the network, a channel plan can be calculated and set for each eNB by the network management system 308A. The process of starting spectrum, identifying clean channels and selecting the correct channel for each device in the network is automated through firmware and network management software, without any user intervention as discussed below with reference to FIGS. 5A and 5B.

Once the filter for the particular frequency band has been selected, the filtering (408) may be performed until the overloading condition is resolved. In the embodiment in which the method 400 is being performed by the system in FIG. 3, a filter bank that is part of each eNB may perform the selected filtering to reduce/eliminate the overloading of the RF front end of the eNB. In the method 400 in FIG. 4, the filter bank may be initially trained so that it has and stores a baseline noise signal for the eNB 304 and each frequency band of the unlicensed spectrum that can be used to assess the overloading of the RF front end of the eNB 304 when the signal is greater than the baseline signal. In the embodiment in which the method 400 is being performed by the system in FIG. 3, these baseline signal(s) may be stored in the network management system 308A or at the eNB 304.

FIG. 5A illustrates more details of an unlicensed spectrum eNB 304 that performs dynamic filtering. In this embodiment, the baseline signals are stored in the network management system 308A and the network management system 308A may determine that overloading is occurring and a user/administrator may select the filtering to be performed using a cloud graphical user interface (GUI) 308A1 that has a filter setting page and a piece of cloud software 308A2 that are both part of the network management system 308A. When the spectrum scan is being performed, the filter selection decision logic may be programmed in the eNB firmware/software. During the normal filtering operations of the system, the filter decision logic may be implemented and executed in the cloud as shown in FIG. 5. The piece of cloud software 308A2 may be executed by a hardware processor of the network management system 308A and may perform the filtering decisions and store the baseline signals for each frequency band.

In the example shown in FIG. 5A, the unlicensed spectrum is television whitespace (TVWS) that has 8 frequency bands between 470 MHz and 630 MHz In the example in FIG. 5, the unlicensed spectrum communication system has two receivers (RX1, RX2). In one embodiment, a user can set each filtering. Note that both filter settings have a “bypass” option in which no filtering is done so that a baseline signal for each frequency band may be determined to train the filters. For example, a particular frequency band may have more noise that other frequency bands, but that additional noise for the particular frequency band is normal and is the baseline signal. In the example in FIG. 5, the filtering settings may be communicated to the eNB 304. The eNB 304 has a system of chip (SoC) integrated circuit (that acts as or includes a hardware processor) 500, eNB software 502 that is executed by the SoC 500 and a filter bank 504 connected to both the SoC and software that performs the dynamic filtering for the eNB 304. The SoC 500 may a commercially available Marvell integrated circuit. The eNB 304 may further have an radio frequency (RF) front end 506 that receives the filtered signals from the filter bank 504 and may include a low noise amplifier.

FIG. 5B illustrates more details of another embodiment of an unlicensed spectrum eNB 304 that performs dynamic filtering wherein each eNB 304 has the same components as shown in FIG. 5A and described above. In this embodiment, the network management system 308A may include a dynamic filter controller 508 (implemented in hardware or a plurality of lines of computer code/instructions executed by a processor of the network management system 308A) that receives a set of network configuration data and then programmatically determines a set of filter control signals for each base station/eNB 304 as described above. The dynamic filter controller 508 may update/change these filter control signals wherever the network configuration data changes for any of the base stations (to perform dynamic filtering) in the network wherein the changes can be a new TV transmitter creating interference, a TV transmitter being shut down, a change in the RF channel for the base station and the like. The network configuration data may include the spectrum scan data from one or more of the base stations/eNB 304 (from which the channel conditions of each base station/eNB 304 may be determined), a location (distance and/or elevation) for each interfering TV transmitter, the presence of a new interfering TV transmitter and/or the shutting down/elimination of a previously interfering TV transmitter.

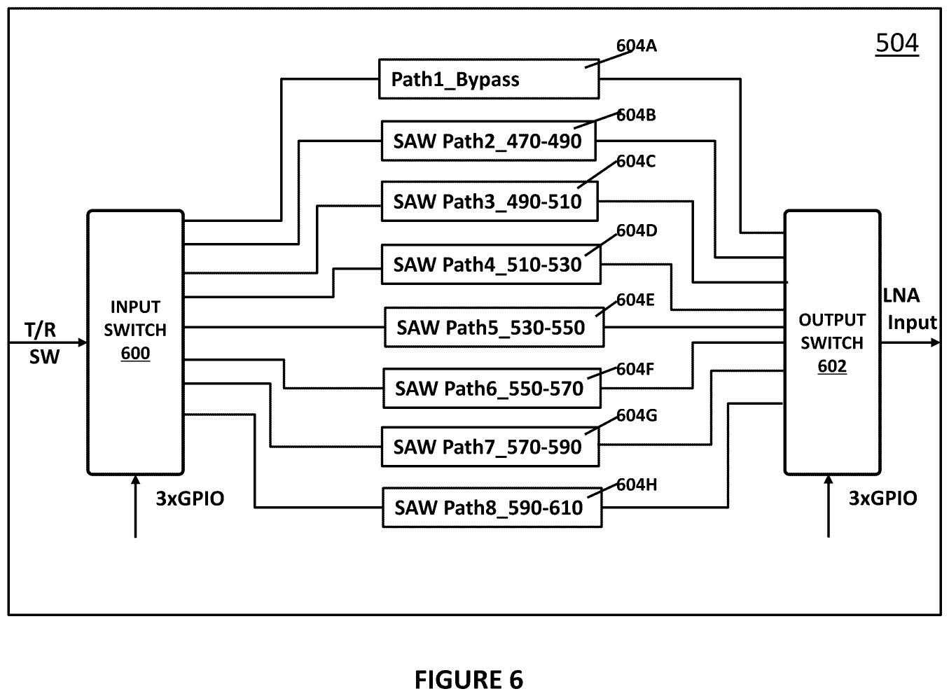

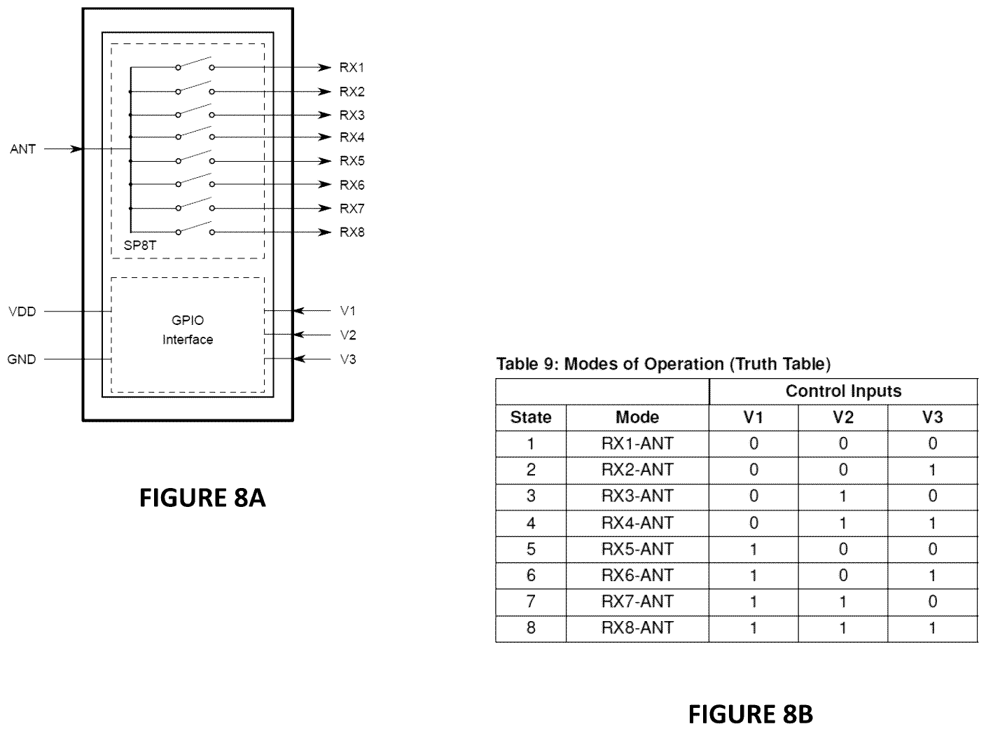

FIG. 6 illustrates an example of an implementation of a filter block 504 for performing dynamic filtering for a TVWS unlicensed spectrum communication system that has the various frequency bands for TVWS. For both FIGS. 5-6, it is understood that if a different unlicensed spectrum is used (Wi-Fi or CBRS, for example), then the frequencies and frequency bands shown in FIGS. 5-6 may be different but would be in the scope of this disclosure. The filter bank 504 may have an input switch 600 that selects the filtering path based on three input signals, such as GPIO signals, based on the selection/controls signals input to the switch, a filter bank 604 with one or more filter paths and an output switch 602 that is also controlled by the three input signals, such as GPIO signals to route the selected filtered signal to the low noise amplifier (LNA) of the RF front end 506 of the eNB 304. Each switch 600, 602 may be a simple pole, multi through RF switch that has a 4-bit control. For example, in one implementation, each switch 600, 602 may be a Infineon BGS18GA14 2×2 mm single pole eight through commercial available switch that is described in more detail below with reference to FIGS. 8A and 8B.

In the example in FIG. 6 for the TVWS spectrum, the filter bank 604 may have a bypass path 604A (to determine a baseline as discussed above), a first surface acoustic wave (SAW) filter for a first frequency band (470-490 MHz) 604B and several other SAW filters 604B-604H for the other frequency bands. In one implementation, each filter is fixed, but each filter may also be programmable within a certain limit. The selection of the filtering path used is performed by the input switch 600 and output switch 602 so that the signal to be filtered goes through the relevant filter path and is then input to the LNA.

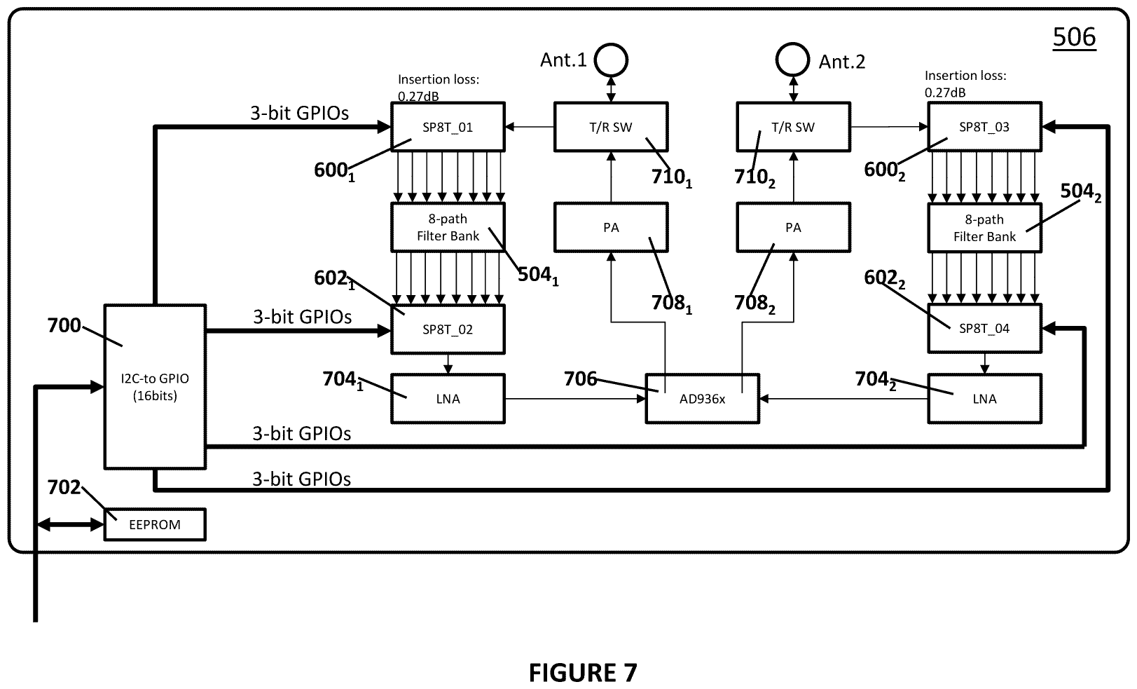

FIG. 7 illustrates an example of an implementation of a television whitespace (TVWS) front end 506 that can perform dynamic filtering and the dynamic filtering method shown in FIG. 4 and discussed above. This front end 506 may be connected to and controlled by the SoC of the eNB. The eNB may also have a bus expander 700, such as an I2C to GPIO (16 bit) bus expander (for example a commercially available Texas Instruments TCA9535) that sends control signals to each of the switches and an EEPROM 702 that is also connected to the SoC. In this embodiment, the front end 506 may have two transceivers (transmitter and receiver) with two antennas (Ant. 1, Ant. 2). Each transceiver thus has the input switch 600₁, 600₂ and output switch 602₁, 602₂ and a filter bank 504₁, 504₂ so that the RF signal to each antenna may be dynamically filtered. Each transceiver has an low noise amplifier (LNA) 704₁, 704₂ that receives the filtered output from the output switches. The output of both LNAs (the resulting amplified filtered signal) are input into an RF transceiver integrated circuit 706, such as an commercially available Analog Devices AD936x device. For each transceiver, the output from the RF transceiver integrated circuit 706 may be input to an RF power amplifier (PA) 708₁, 708₂ that outputs signals to a transmitter/receiver switch 710₁, 710₂ that are each connected to the input switch 600₁, 600₂ and the antennas Ant. 1 and Ant.2.

FIGS. 8A and 8B illustrate a switch integrated circuit and its truth table wherein the switch integrated circuit may be used to perform dynamic switching. In one implementation of the dynamic switching, an Infineon BGS18GA14 SP8T switch that has the functions shown in FIG. 8A. An example of the mode of operation of the switch based on the control signals are shown in FIG. 8B.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A dynamic filtering method, comprising:
receiving a spectrum scan of one or more unlicensed spectrum frequency bands from a base station of an unlicensed spectrum communication system;
determining, using the spectrum scan, if a radio frequency front end (RFE) of the base station is overloaded by a second transmitter transmitting using a particular frequency band;
controlling a filter bank in the base station to select filtering of the particular frequency band when the base station RF front end is overloaded; and
performing, by the filter bank in the base station, filtering in the particular frequency band.

2. The method of claim 1, wherein the unlicensed spectrum is television whitespace and the second transmitter is a television broadcast transmitter located adjacent to the base station.

3. The method of claim 1, wherein the unlicensed spectrum is one of CBRS and Wi-Fi.

4. The method of claim 1, wherein determining if the RFE of the base station is overloaded further comprises determining, at a network management system connected to the base station, if the RFE of the base station is overloaded based on the spectrum scan.

5. The method of claim 1, wherein determining if the RFE of the base station is overloaded further comprises determining, at the base station, if the RFE of the base station is overloaded based on the spectrum scan.

6. The method of claim 1 further comprising generating, at the base station, the spectrum scan based on a set of baseline filter settings in the base station.

7. The method of claim 1, wherein controlling the filter bank further comprises determining, in a network management system connected to the base station, one or more filter control signals for the filter bank and wherein performing the filtering further comprises performing, based on the one or more filter control signals, filtering in the particular frequency band.

8. The method of claim 7, wherein determining the one or more filter control signals for the filter bank further comprises recalculating the one or more filter control signals for the filter bank when a channel condition of the base station changes.

9. The method of claim 7, wherein determining the one or more filter control signals for the filter bank further comprises determining the one or more filter control signals for the filter bank based on a set of network configuration data.

10. The method of claim 9, wherein the set of network configuration data includes a channel condition of the base station generated from the spectrum scan and a location of the second transmitter.

11. A system, comprising:
an unlicensed spectrum communication system having a network management computer system;
a hardware base station for the unlicensed spectrum communication system that is coupled to the network management computer system;
the network management computer system having a hardware processor that executes a plurality of instructions to configure the hardware processor to receive a spectrum scan of unlicensed spectrum and determine, using the spectrum scan, if an radio frequency (RF) front end of a base station of an unlicensed spectrum communication system is overloaded by a second transmitter transmitting using a particular frequency band; and
the hardware base station having a hardware processor connected to a filter bank with a plurality of filters, wherein each filter performs filtering on a particular unlicensed spectrum frequency band when the base station is overloaded in the particular unlicensed spectrum frequency band.

12. The system of claim 11, wherein the unlicensed spectrum is television whitespace and the second transmitter is a television broadcast transmitter located adjacent to the base station.

13. The system of claim 11, wherein the unlicensed spectrum is one of CBRS and Wi-Fi.

14. The system of claim 11, wherein the base station is configured to generate the spectrum scan based on a set of baseline filter settings in the base station.

15. The system of claim 11, wherein the network management computer system is configured to determine one or more filter control signals for the filter bank and wherein the hardware base station is configured to perform filtering in the particular frequency band based on the one or more filter control signals.

16. The system of claim 15, wherein the network management computer system is further configured to recalculate the one or more filter control signals for the filter bank when a channel condition of the base station changes.

17. The system of claim 15, wherein the network management computer system is further configured to determine the one or more filter control signals for the filter bank based on a set of network configuration data.

18. The system of claim 17, wherein the set of network configuration data includes a channel condition of the base station generated from the spectrum scan and a location of the second transmitter.

19. An apparatus, comprising:
a base station that is part of an unlicensed spectrum communication system, the base station having a processor connected to a filter bank having a plurality of filters that is connected to a radio frequency front end (RFE);
the processor of the base station being configured to:
receive a spectrum scan of unlicensed spectrum;
determine, using the spectrum scan, if the RFE is overloaded by a second transmitter transmitting using a particular frequency band;
filter, using one or more filters of the filter bank, the particular frequency band when the base station is overloaded in the particular unlicensed spectrum frequency band.

20. The apparatus of claim 19, wherein the unlicensed spectrum is television whitespace and the second transmitter is a television broadcast transmitter located adjacent to the base station.

21. The apparatus of claim 19, wherein the unlicensed spectrum is one of CBRS and Wi-Fi.

22. The apparatus of claim 19, wherein the processor is further configured to generate, at the base station, a spectrum scan based on a set of baseline filter settings in the base station.

23. The apparatus of claim 19, wherein the processor of the base station is further configured to receive, from a network management computer system, one or more filter control signals for the filter bank and filter in the particular frequency band based on the one or more filter control signals.

24. The apparatus of claim 23, wherein the processor of the base station is further configured to receive, from a network management computer system, one or more filter control signals for the filter bank based on a set of network configuration data.

25. The apparatus of claim 24, wherein the set of network configuration data includes a channel condition of the base station generated from the spectrum scan and a location of the second transmitter.
